(19) United States
(12) Patent Application Publication
(10) Pub. No.: US 2009/0276719 A1
(43) Pub. Date: Nov. 5, 2009

(54) USER INTERFACE METHOD AND APPARATUS FOR ONLINE INTERACTIVE GIFT REGISTRY

(75) Inventor: Pedraum Pardehpoosh, Palo Alto, CA (US)

Correspondence Address: Apple Inc.;c/o Novak Druce + Quigg LLP, 1000 Louisiana Street, Fifty-Third Floor, Houston, TX, 77002, US

(73) Assignee: Apple Inc., Cupertino, CA (US)

(21) Appl. No.: 12/113,088

(22) Filed: Apr. 30, 2008

(51) Int. Cl. G06F 3/00

(52) U.S. Cl. 715/762

(57) ABSTRACT

A method is provided to promote the acquisition of a set of items comprising: sending requester GUI controls over a network to a requestor's electronic device; receiving from the requestor's device over the network assembly instructions for a contribution solicitation object; and sending the object and contributor GUI controls over the network to a contributor's electronic device.

### BACKGROUND OF THE INVENTION

1. Field of the Invention

The invention relates in general to computer networks, and more particularly, to user interfaces for online transactions.

2. Description of the Related Art

Limited virtual ‘shelf space’ is a problem with online stores just as limited physical shelf space is a problem in brick and mortar stores. The online problem is not with the storage capacity, but rather with alerting potential purchasers of new product offerings. As the product line offered for sale through an online store expands, the challenge of informing consumers of changes to the product mix becomes more severe. The average time spent on websites is low, and attention is easily diverted by the myriad of online shopping options. This problem is exacerbated by the need to inform potential buyers of new products in the crowded, fragmented and seemingly ethereal marketplace that is the World-Wide-Web.

Collaborative filtering is one potential solution to the problem of informing consumers of other products in an online store environment. When a user expresses an interest in an item such as by selecting the item for possible purchase, the user is informed of other items that other purchasers of that item also purchased. Another possible solution is to show a potential online buyer other compatible products. For example, if a potential buyer is considering an online offering of a handheld phone, then that prospective purchaser is presented with a protective cover for that phone.

While prior approaches to alerting potential online purchasers to other online products generally have been effective, there has been a need for improvement. The present invention meets this need.

### SUMMARY OF THE INVENTION

In one aspect, a method is provided to promote the acquisition of a set of items. In some embodiments, a server sends first graphical user interface (GUI) controls over a network to a first device. The first GUI controls allow a requester of a set of items to use the first device to assemble an object that presents a personalized request for the items. The personalized request may include reasons why the requester wants to acquire the items, for example. The object may be implemented as a portion of a web page. An object assembled in accordance with the instructions is sent together with second GUI controls over the network to a second device. The object and the second instructions, for example, may be used by the second device to produce a web page that presents a visual display of the object and second GUI controls. The second GUI controls allow a potential contributor to respond to a request presented through the object by making a contribution.

Thus, a requester can assemble an object over a network that groups together a set of items offered for purchase through an online store, for example, and present the object over the network to potential contributors to request contributions toward the acquisition of such items. In creating the object and presenting it to potential contributors, the requester in effect acts to inform the contributors of different items in inventory in an online store, for example. A requester who wants a set of items for his or her personal or professional reasons is likely to be highly motivated to research items in inventory and to set forth to potential contributors through the assembled object, compelling reasons for the request for the group of items.

These and other features and advantages of the invention will be apparent to persons skilled in the art from the following detailed description of embodiments thereof in conjunction with the appended drawings.

### BRIEF DESCRIPTION OF THE DRAWINGS

FIG. 1A is an illustrative timing diagram for a process to create and use a contribution solicitation object in accordance with some embodiments of the invention.

FIG. 1B is an illustrative drawing of a Web architecture in accordance with some embodiments.

FIGS. 2A-2B are illustrative drawings of web page screen displays that include a graphical user interface (GUI) control to select the displayed item.

FIG. 3 is an illustrative drawing of a new object creation screen display resulting from user selection of the “add list” menu option of FIG. 2B.

FIGS. 4A-4C are illustrative drawings of screen displays of a contribution solicitation object and requester user interface controls during different stages of assembly and use of such object in accordance with some embodiments of the invention.

FIG. 5 is an illustrative flow diagram of a computer program controlled process by which a ‘requesting’ user of device may use requester user interface controls to assemble a new contribution solicitation object or may add an item to an existing contribution selection object in accordance with some embodiments of the invention.

FIG. 6 is an illustrative screen display including the contribution solicitation object of FIGS. 4A-4C and contributor user interface controls produced on a display screen of a second device operated by a potential contributor in accordance with some embodiments of the invention.

FIG. 7 is an illustrative flow diagram of a computer program controlled process by which a ‘contributor’ user device may use contributor user interface controls to make a contribution in response to the requests articulated by a contribution solicitation object in accordance with some embodiments of the invention.

FIG. 8 is an illustrative block level diagram of a processing system that can be programmed to implement processes involved with assembling a contribution solicitation object and with sending first controls over a network to a requestor's device and with sending second controls with the object over a network to a potential contributor's device in accordance with some embodiments of the invention.

The aforementioned features and advantages of the invention, as well as additional features and advantages thereof, will be more clearly understandable after reading detailed descriptions of embodiments of the invention in conjunction with the following drawings.

### DETAILED DESCRIPTION OF THE PREFERRED EMBODIMENTS

The following description is presented to enable any person skilled in the art to make and use a method and apparatus to assemble and share an object over a network to solicit monetary toward the acquisition of items identified within the object, in accordance with embodiments of the invention, and is provided in the context of particular applications and their requirements. Various modifications to the preferred embodiments will be readily apparent to those skilled in the art, and the generic principles defined herein may be applied to other embodiments and applications without departing from the spirit and scope of the invention. In the following description, numerous details are set forth for the purpose of explanation. However, one of ordinary skill in the art will realize that the invention might be practiced without the use of these specific details. In other instances, well-known structures and processes are shown in block diagram form in order not to obscure the description of the invention with unnecessary detail. Furthermore, in order to more efficiently illustrate and describe embodiments of the invention, identical reference numerals are used in the specification and drawings to identify parts that are essentially the same in different stages, versions or instantiations of such parts shown in the drawings. Thus, the present invention is not intended to be limited to the embodiments shown, but is to be accorded the widest scope consistent with the principles and features disclosed herein.

### Overview

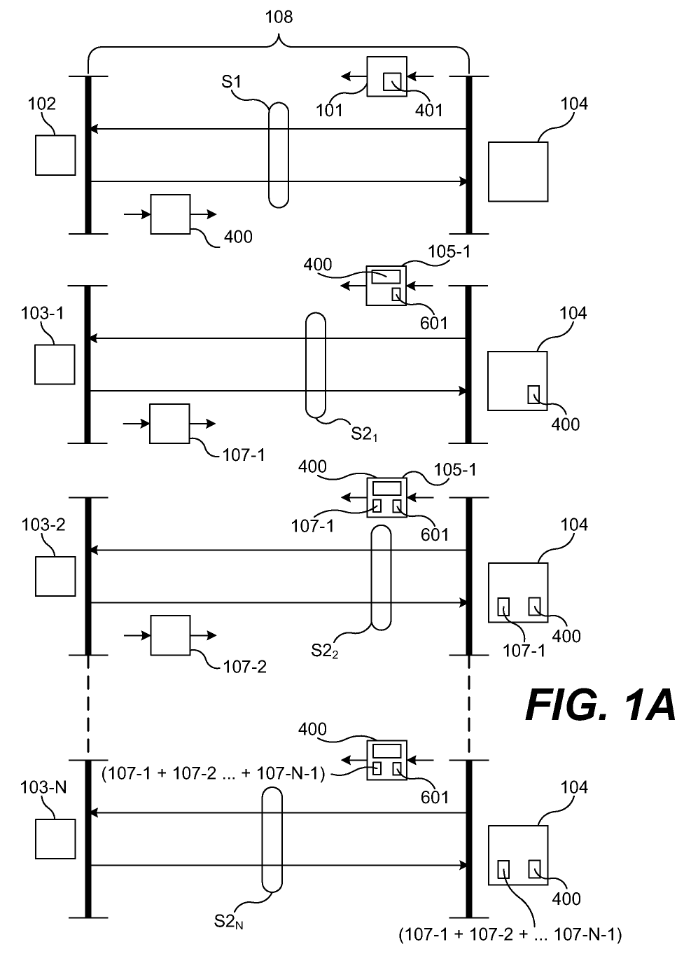

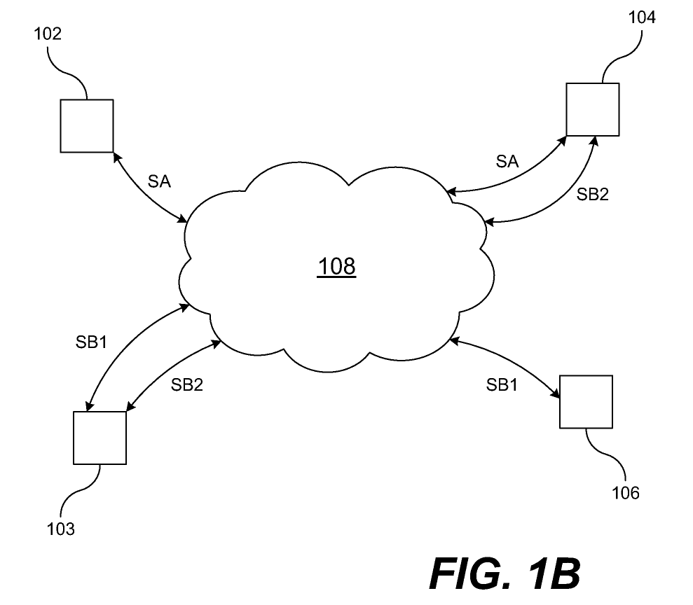

FIG. 1A is an illustrative timing diagram for a process to create and use a contribution solicitation object 400 in accordance with some embodiments of the invention. Such object comprises computer readable code encoded in a computer readable medium used by a computing device to generate at least a portion of a web page. As used herein, the term ‘contribution solicitation object’ (or ‘object’) shall refer interchangeably to code used to generate at least portions of a web page display and to that portion of a web page displayed using the object. A person or other entity who shall be referred to as a ‘requester’ uses the object to solicit contributions over a computer network 108 toward the acquisition of items identified by the object from other persons or entities who shall be referred to as ‘contributors’.

At time T₁, a requestor using a first device 102 establishes a first session S1 over the network with a first server 104. During the first session, the first server 104 delivers a web page 101 to the first device 102 that includes first controls, referred to herein as requestor Graphical User Interface (GUI) controls 401, for use in the assembly of the object. Through an exchange of information over the course of the first session, the requestor user produces information concerning assembly of the object 400 using the requestor GUI controls provided by the first server 104. The information concerning assembly of the object is transmitted from the first device 102 to the first server 104 in the course of the first session S1.

At time T₂, a first potential contributor, using device 103-1 establishes a second session S2₁ over the network 108 with the first server 104. During the second session, the first server 104 delivers a web page 105-1 to the first contributor that includes the object 400 assembled by the requestor. The web page also includes second controls, referred to herein as, contributor GUI controls 601 for use by the first contributor in making a contribution in response to a request embodied in the object 400. The web page also includes an indication 410-414 of contributions made by other contributors. In the case of this first contributor, the indication would show no prior contributions. In the course of the second session, the first contributor indicates a first contribution amount 107-1, which is recorded in computer storage associated with the first server 104-1.

At time T₃, a second potential contributor, using device 103-2 establishes a third session S2₂ over the network 108 with the first server 104. During the third session, the first server 104 delivers a web page 105-2 to the second contributor that includes the object 400 assembled by the requestor. The web page also includes the contributor GUI controls 601 and an indication 410-414 of contributions made by other contributors. In the case of this second contributor, the indication would show prior contribution 107-1 by the first contributor. In the course of the second session, the second contributor indicates a second contribution 107-2 amount, which is recorded by in computer storage.

This process of contributing toward the requests embodied in the object 400 may continue through to time TN at which time all requests set forth in the object have been fulfilled or until the occurrence of some other designated event or milestone. As explained below, a requester can make a customized request that can be targeted to a specific group of potential contributors. The first server 104 keeps track of cumulative contributions (105-1+105-2+ . . . +105-N), and potential contributors are apprised of the status of the contribution effort through indications 410-414 as they decide whether or how much to contribute. Note that although this simplified example shows sessions occurring at different time intervals, it will be understood that sessions may overlap in time.

### Web Architecture

The first and second user devices 102 and 103 may comprise personal computers, laptops, notebook computers, personal digital assistants, network-attached storage, cellular phones, media centers, set-top boxes, or other devices or combinations of devices, for example. In order to simplify the description, second (contributor) devices 103-103N of FIG. 1A are referred to collectively in FIG. 1B using reference numeral 103. The first server 104 may comprise one or more hardware systems or may comprises computer program processes running on hardware systems. Such hardware systems may be part of a geographically dispersed ‘server farm’, for example. An online seller may operate the first server 104 to run an online commerce site such as an online store.

FIG. 1B is an illustrative drawing of an example Web architecture in which a third party server 106 provides a link to the server 104 that manages the object 400 in accordance with some embodiments. A requestor's device 102 establishes a session S_{A} with the first server in which the requester assembles the first object 400 as described below in detail. A contributor's device 103 establishes a session S_{B1} with a third party server 106 in which the contributor seeks to make a contribution in response to the promotion. The third party server 106, for example, may promote the object 400 through a ‘social network’ server to which both the requestor and the contributor belong or through a private blog used by the requester. In response to the user request in session S_{B1}, the third party server 106 may cause establishment of a session S_{B2} between the contributor's device 103 and the first server 104, through hyperlinking, for instance, whereby the contributor can contribute. Thus, the requestor device 102 is used to create ‘content’ in the form of object 400 that can be syndicated through server 106 for delivery upon request to contributor device 103 over the network 108.

The same or a different online provider may operate the second server 106 that may support a ‘social networking site’ or a personal blog site, for example, that the requesting user may choose to employ to notify potential contributors of requested items offered through an online store operated using the first server 104.

The network 108 provides communications over the Worldwide Web (the “Web”), which provides access to a distributed collection of documents or more generally, a collection of files via the Internet. The Web uses a client-server model in which servers referred to as a Web servers, serve database records to client devices. Information extracted dynamically over the Web from the distributed database is displayed to users in the form of “web pages. Thus, the object 400 may be combined dynamically in a web page that also includes requestor GUI controls 401 for delivery to a requestor's device 102. Alternatively, substantially the same object 400 may be combined dynamically in a different web page that also includes contributor GUI controls 601 for delivery to a potential contributor's device 103.

The Web, therefore, provides access to a vast database of information dispersed across an enormous number of individual computer systems. Computers connected to the Internet may search for and retrieve Web pages via a computer program known as a browser, which has a powerful, simple-to-learn graphical user interface. One technique supported on a Web browser is known as hyperlinking, which permits Web page authors to create links to other Web pages that users then can retrieve by using simple point-and-click commands on the Web browser. Web pages may be constructed in any of a variety of formatting conventions, such as Hyper Text Markup Language (HTML), and may include multimedia information content such as graphics, audio, and moving pictures.

During communications sessions, the respective first and second servers 104, 106 may send instructions over the network that include code such as HTML instructions and Java applets and associated data. The web pages delivered using such instructions and data may include hyperlinks to web pages delivered by other servers (not shown). The web pages may include text, user actuated controls such as a ‘dashboard’ for a media player, animated images or video, for example.

The display of an interactive web page by first and/or second devices 102, 103 often requires exchanges of small amounts of information behind the scenes so that there is no need to reload a web page each time there is a need to fetch more data from the server 104 or 106, for example. Asynchronous JavaScript And XML, or AJAX, is an example of a group of inter-related web development techniques used for creating interactive web applications. AJAX is asynchronous, in that the first or second devices 102, 103 may request additional information from the server 104 or 106, and load the information in the background without interfering with the display and behavior of a previously downloaded page. JavaScript is the scripting language in which AJAX function calls usually are made. Typically, data is retrieved using an XMLHttpRequest object that is available to scripting languages run in a browser on the user devices 102, 103 or alternatively, through the use of Remote Scripting in a browser that does not support XMLHttpRequest. In any case, it is not required that the asynchronous content be formatted in XML.

### Assembling a Solicitation Request Object

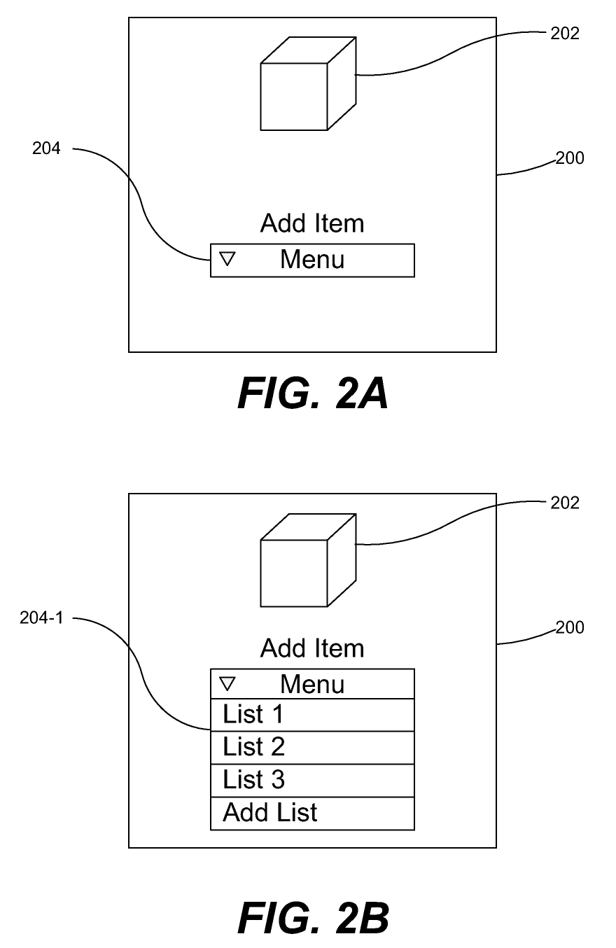

FIGS. 2A-2B are illustrative drawings of an electronic device screen display 200 that includes an image of an item 202 that may be offered for sale and a menu selection interface 204 in accordance with some embodiments of the invention. The item may be a product or a service offered for sale through a web page served by the first server 104 to the first user device 102 for display on its display screen 112, for example. The first server 104 may be used as part of an implementation of an online store, which comprises a large collection of related web pages used offer and sell many different products or services. Different web pages may be used to offer and sell different products or services, for example.

The screen display 200 of FIGS. 2A-2B may comprise a web page that includes a GUI button 204 that a user may actuate through point-and-click action to select the displayed item. Referring to FIG. 2B, actuation of the GUI button 204 results in display of a pull down menu. The screen display 200 may be one of a multitude of screen displays (not shown) that can be served by the first server 104 and that collectively comprise an online store, through which the displayed item is offered for sale. It will be understood that the screen display 200 may include other images (not shown) corresponding to other items offered for sale and may include other GUI controls, which are not shown so as to simplify the description of embodiments of the invention.

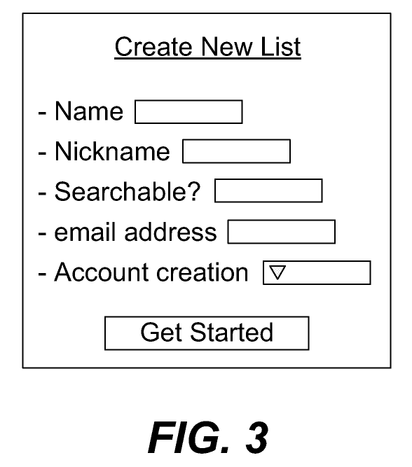

FIG. 3 is an illustrative drawing of a new object creation screen display 300 resulting from user selection of the “add list” menu option of FIG. 2B. The list creation display 300 may comprise a web page served by the first server 104 or an overlay to such previously downloaded webpage. The display 300 includes a set of GUI controls to guide a user through a process of creating a solicitation request object to which the displayed item 202 can be added. Referring to FIG. 2B, the list of menu selections 204-1 displayed by the pull down menu includes, “list 1”, “list 2”, “list 3” and “add list”. A user selection of the “add list” menu selection results in device 102 requesting a web page from the first server 104. In some embodiments, the “add list” menu selection is associated with a hyperlink to the object creation web page 300. It will be appreciated that, alternatively, hyperlinking can be used to initiate creation of a new list from other webpages/sites (not shown). A selection by a user of the first device 102 of the “add list” choice from the menu 204-1 results in transmission of a request 102-1 to the first server 104 for transmission of first instructions 104-1 used by the first device 102 to generate a object creation web page 300 for display by its associated display screen 112.

As shown in FIG. 3, the object creation display 300 includes GUI fields to receive several types of information used to create the new object. Note that the object creation screen 300 refers to creation of a new “list” rather than creation of a software code based entity. Ordinary users typically think in terms of lists of things they want rather than in terms of a software based objects suitable for transmission the over the Internet, which is what in fact they actually are creating. In some embodiments, the object creation screen 300 includes fields for the user to indicate his or her name, a nickname for the new list/object, whether the list/object is to be searchable by third parties, a user email address, and whether a user account is to be created for the purchase of items. User account information provides identifying information to track purchases and may be password protected, for example. Once the user responds to the requests, the user may actuate a GUI “get started” button on the screen to continue a process of adding an indication of an item to a newly created object.

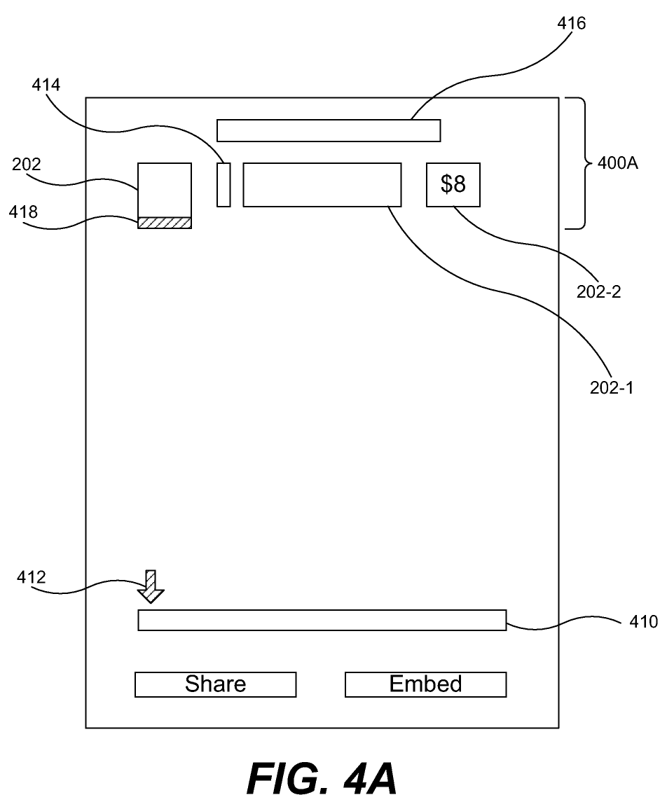

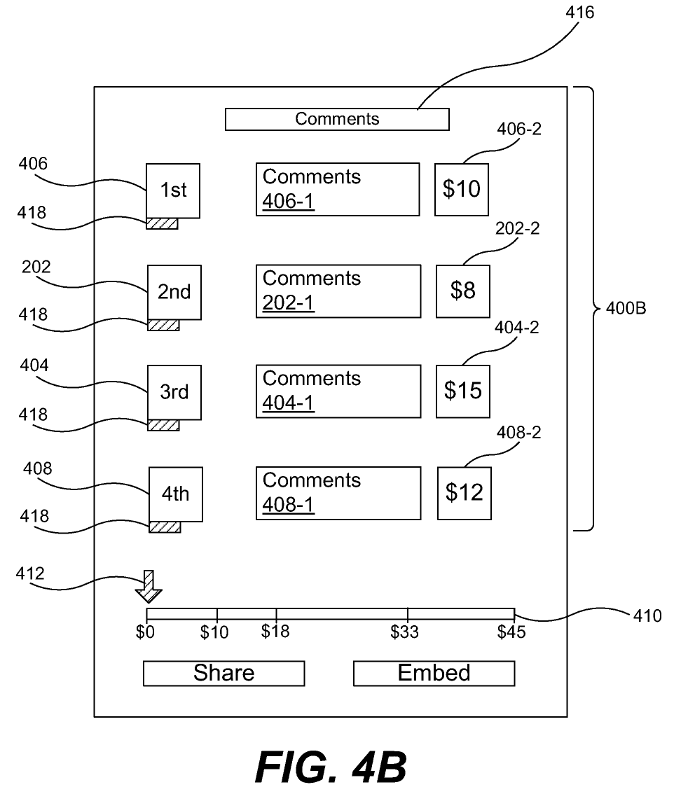

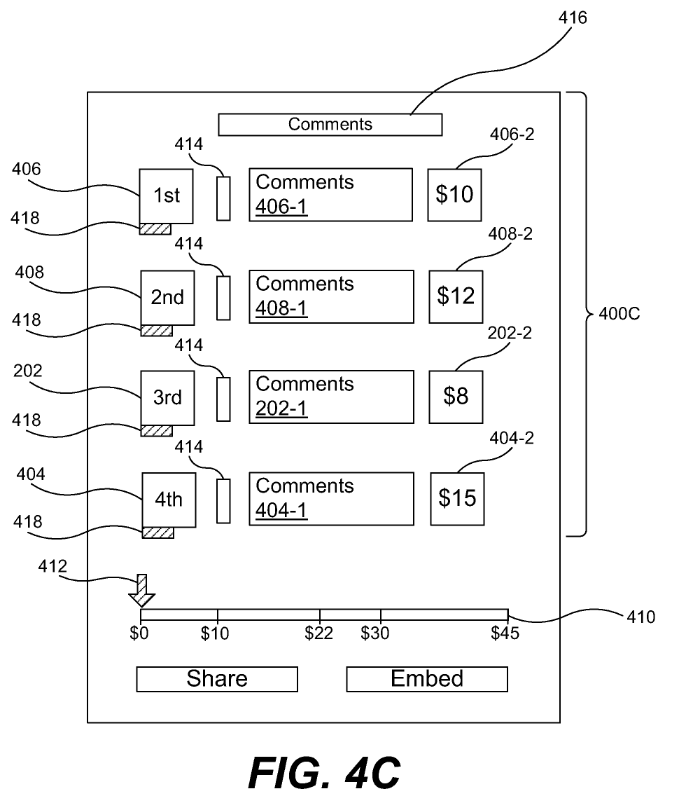

FIGS. 4A-4C are illustrative drawings of screen displays of a contribution solicitation object 400A-C and requester GUI controls 401 during different stages of assembly and use of such object in the course of a first session SA in accordance with some embodiments of the invention. A solicitation request object 400A-C is a user-assembled object embodied in a computer readable medium encoded to provide a display in the context of a web page of a group of items sought by such user. The object displays of FIGS. 4A-4C show different stages in the assembly of a contribution solicitation object by a user of the first device 102 to solicit the acquisition or purchase of items identified in the object display by prospective contributors who are users of the one or more second devices 103. The same requester GUI controls 401 are displayed during each assembly stage.

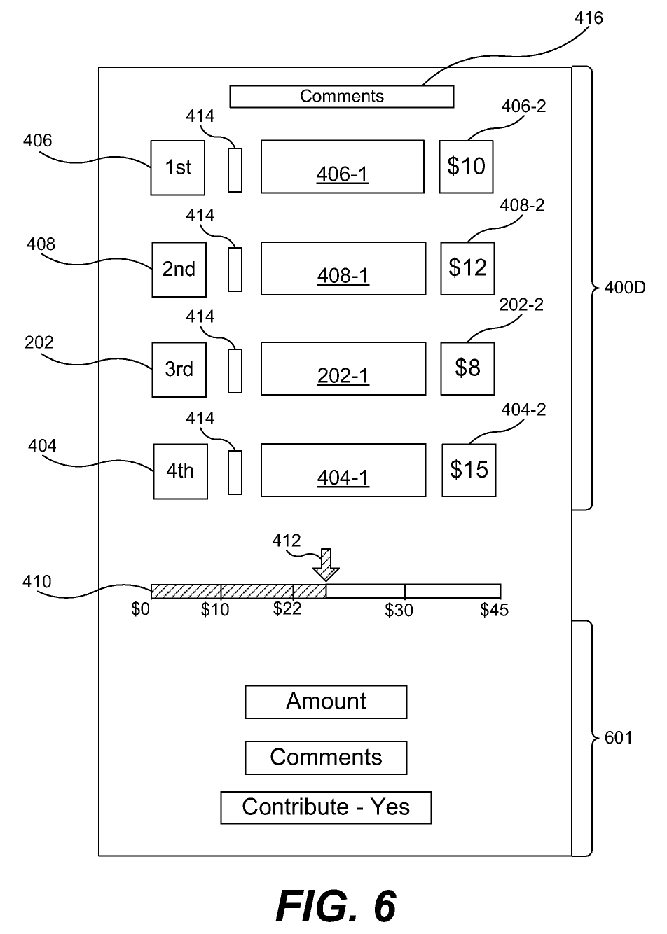

Moreover, as explained below with reference to FIG. 6, such object also is used by device 103 to produce an associated web page display on its associated display screen 113.

FIG. 4A shows a display of the object 400A in its initial stages of assembly when it includes only a single ‘new’ item 202. The initial stage item 400A includes an image of item 202, an associated comments field 202-1. A requesting user of the first device 102 can insert comments related to the item 202 in its associated comments field 202-1. The item 202 also is associated with a price field 202-2. The initial stage object 400A also includes an introductory comments field 408 in which a requesting user can insert comments of a more general nature, for example.

FIG. 4B shows a later stage display of the object 400B following the prior inclusion of three items 202, and 404-406 and in which another ‘new’ item 408 has been added but has not yet been prioritized. In particular, in the object display 400B of FIG. 4B, items 202 and 404-406 were previously added and prioritized relative to each other, but ‘newest’ item 408 was added to the object 400B but has not yet been prioritized. In this example, the newest object 408 is provisionally added to the ‘end’ of the list of items in the display for object 400B display. Each item is associated with a corresponding comments field. Item 202 is associated with comments 202-1 field; item 404 is associated with a comments field 404-1, etc. A requesting user of the first device 102 can insert comments about an item in its corresponding field. Each item also is associated with a price field. Item 202 is associated with price field 202-2; item 404 is associated with a price field 404-2, etc.

FIG. 4C shows a still later stage display of the object 400C following the inclusion of all four items 202 and 404-408 and prioritization of these items relative to each other. In some embodiments, the user may achieve prioritization of items by placing them in a prioritized order. The priority may represent how much the user wants or needs each of the items in the group relative to other items in the group. For example, item images can be arranged in a list with the highest priority item shown at the top of the list, and the lowest priority item may be shown at the bottom of the list. Referring to FIG. 4C, with such prioritization framework in mind, item 406 has the highest 1^{st} priority; item 408 has the next 2^{nd} highest priority; 202 has the third (3^{rd}) highest priority; and item 404 has the lowest 4^{th} priority in this example.

The illustrative screen displays of FIGS. 4A-4C also include requester GUI controls comprising buttons labeled “share” 401-1 and “embed” 402-2 and GUI grabber fields 403-1 and comments fields associated with the object stages 400A-C. The share button is used to share the objects 400A-C with others through posting a link on a different site such as server 406 for distribution via email, block, or embedding, for example. For example, in some embodiments, a requester may copy a snippet of code (not shown) and paste it into the body of a site 406 such that the object 400 is displayed in line on such third party site. The illustrative displays 400A-C also includes a GUI contribution meter 410, a progress marker 412 and purchase status field 414 that can be used to indicate contributor commitments and that are described more fully below.

Thus, it will be appreciated that the display screens of FIGS. 4A-4C include display sections representing different stages 400A-C in the assembly of an object that is to be shared with potential contributors. Requestor GUI controls 401-1, 401-2 operated by a requesting user of first device 102 are used to assemble the object. Subsequently as explained more fully below with reference to FIG. 6, a potential contributor uses the second device 103 to display the assembled object 400D together with contributor GUI controls 601 used to make a contribution based upon requests articulated through the assembled object.

Referring again to FIG. 3, for example, a user may initiate a request over the network 108 to the first server 104 for a web page for the initial stage object 400A of FIG. 4A by actuating the “get started” button. In response, the first server 104 sends a instructions to the first device 102 over the network 108 to cause the device to produce the web page display of FIG. 4A. After the new object 400A has been created, it is associated through a hyperlink to the pull down menu 204 of FIGS. 2A-2B.

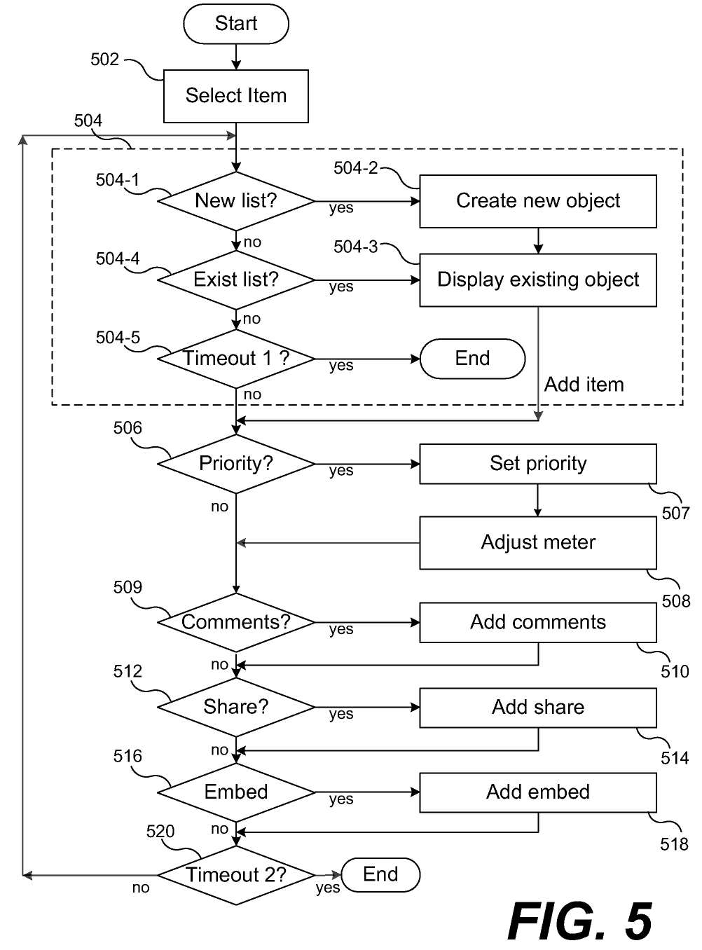

Assume, for example, that the new object is automatically hyperlinked to the “list 1” menu item. Further assume that subsequently, through a series of user actions, which are not shown but which will be understood from the explanation below of FIG. 5, a user adds additional items 404 and 406 to the object. Still further, assume that the user selects another item 408 from the online store and then selects “item 1” from the pull down menu 204-1. Such actuation by the user causes the first device 102 to request from the first server 104 delivery of a web page for the object 400B in the stage of assembly represented by FIG. 4B.

Later, after the user has re-prioritized items 202 and 404-408 relative to each other, the user again may actuate the “list 1” menu option, but this time in the absence of a request to add a new item. Such later actuation results in the first device 102 requesting from the first server 104 delivery of a web page for the object 400C in the stage of assembly represented by FIG. 4C.

FIG. 5 is an illustrative flow diagram of a computer program controlled process 500 by which a ‘requesting’ user of device 102 may use the requester GUI controls to assemble a new contribution solicitation object or may add an item to an existing contribution selection object. Computer readable media is encoded with program code to implement the process 500. In some embodiments, the first server 104 cooperates with the first device 102 during implementation of the process 500. In particular, the first server 104 delivers information in the form of web pages such as web pages shown in FIGS. 2A-4C through which the user of the first device assembles the object stages of FIGS. 4A-4C.

A user initiates process 500 through user action that causes a select item block 502 to select an item for addition to a new or existing contribution selection object. Referring to FIG. 2A, for example, a user may select item image 202 by point-and-click of a mouse device. Through user action, add item block 504 shown within dashed lines initiates a user controlled process to add the selected item to either a new or existing contribution solicitation object.

The add item block 504 includes several sub-blocks. Referring to FIG. 2A, in some embodiments, the user initiates the add item block by actuating an “add item” button to reveal pull-down menu options 204-1 such as those shown in FIG. 2B. Decision sub-block 504-1, determines whether the user selects the “add list” option. If decision sub-block 504-1 determines that the user has selected the “add list” option, then in create new object sub-block 504-2, the screen 302 of FIG. 3 is displayed on user device display 112, and the user is guided through actions described above that result in assembly of a new contribution solicitation object. Assuming that the user selected item 202 of FIGS. 2A-2B the initial object display 400A shown in FIG. 4A will be produced in response to actuation of the “get started” button as described above. More particularly, actuating the “get started’ button will cause the existing object display sub-block 504-3 to cause the newly created (now ‘existing’) object 400A to be displayed on screen 112 as described above.

If decision sub-block 504-1 determines that the user has not selected the “add list” option, then decision sub-block 504-4 determines whether the user has selected an existing contribution selection object. Referring to FIG. 2B, the user may have selected one of “list 1”, list 2” or list 3”, for example. If the decision sub-block 504-4 determines that the user has selected one of those existing list options, then existing object display sub-block 504-3 causes an existing object corresponding to the selected list to be displayed on screen 112. The existing object has added to it the selected item, in this example item 202. Continuing for a moment with the example of FIG. 4B, if the user selects item 408 as the newest item and also selects the “item 1” menu option, then display screen 112 displays object display 400B as described above.

Thus, if either sub-block 504-1 or 504-4 is operative, then process 500 next flows to sub-block 504-3. However, if decision sub-block 504-4 determines that the user has made no selection of an existing object, then the process 500 proceeds to a first timeout decision sub-block 504-5. If a first prescribed amount of time has elapsed since the user initiated processing by the select item block 502 without either causing selection of a new or an existing object, then the process 500 ends. If the prescribed amount of time has not elapsed, then the flow of process 500 returns to decision sub-block 504-1. Assuming for the moment that the process 500 moved to the sub-block 540-3, then following operation of that sub-block 504-3, which causes display of an existing object, flow of process 500 moves to priority decision block 506, which determines whether user input is provided to set the priority of an item. If decision priority block 506 determines that user input is provided to adjust item priority, then priority setting block 507 adjusts the item priority in response to such user action.

Continuing with the above example, assume that the object display 400B of FIG. 4B is displayed as a result of sub-block 504-3. Referring to FIGS. 4B-4C, each item image 404-408 and 202 is associated with a GUI grabber field 401-3. A user can click onto an item's grabber field 401-3 to drag the item image to a different position in the ordering of the items. In some embodiments, an item's position in a list of items represents priority of the item. The higher an item appears in the list of items within a contribution solicitation object, the higher its priority relative to other items included in the object. A user grabs onto an item image's grabber field 401-3 to drag the item to a desired location on the display that is indicative of its priority. Through user interaction with one or more items' grabber fields 401-3, the add priority block 507 sets or changes priority of the newly added item 408 (or any of the other items 202, 404 or 406). It can be seen from FIGS. 4B-4C, that a change in priority position of an item in the object display results in a corresponding change in priority position of associated comments and price fields. The GUI grabber field 401-3 thereby serves as a requester control to adjust item priorities.

Flow of process 500 next moves to an adjust meter block 508 that automatically recalibrates the contribution meter 410. In particular, block 508 automatically adjusts markings associated with the meter 410 to correspond to any user imparted changes in prioritization made through priority setting block 507. For example, prior to user priority adjustment to the object 400B of FIG. 4B, the order of priority of the listed items is 406 (1^{st}), 408 (2^{nd}), 404 (3^{rd}) and 202 (4^{th}). After adjustment, the priority order of the object stage 400C of FIG. 4C is item 406 (1^{st}), item 408 (2^{nd}), item 202 (3^{rd}) and item 404 (4^{th}). The adjust meter block 508 also alters the spacing between priority markings on the meter 410 to indicate the relative monetary difference between items. In other words, for example, referring to FIG. 4B, before operation of the priority block 507, the distance between the “2” and “3” priority locations on the meter 410 is proportionate to a $15 difference since an additional $15 is required to acquire item 404 once sufficient funds have been committed to acquire items 406 and 408. However, referring to FIG. 4C, after operation of the priority block 507 and the adjust meter block 508, the distance between the “2” and “3” priority locations on the meter is proportionate to an $8 difference, since an additional $8 is required to acquire item 202 once sufficient funds have been committed to acquire items 406 and 408.

Flow of process 500 next proceeds to an add comments decision block 509. If comments decision block 509 determines that the user has provided input indicating a desire to enter comments, then add comments block 510 adds the user-entered comments. It will be appreciated that comments can be added for a new item or for previously added items. For example, a user may enter comments to a comments field to explain why he or she wants the associated item or how the item relates to other items or to leave just about any message that the user wants to share in association with the item. It will be appreciated that GUI controls such as point-and-click commands that enable the user to enter comments also comprise part of the requester GUI controls 401.

Flow of process 500 next proceeds to a share object decision block 512. Referring to FIG. 4C, for example, a user may indicate a desire to share object 400C by actuating a “share” button. If as a result of such user action, the share decision object decision block 512 determines that a user has provided input indicating an intent to share the object, then add share block 514 directs a user through a set of options whereby the object may be shared. The options can be simple to use such as presentation of a link that can be copied and pasted to an email, for example.

Flow of process 500 next proceeds to an embed block 516. Referring to FIG. 4C, for example, a user may indicate a desire to invite others to access the object by actuating an “embed” button 401-2. If as a result of such user action, the embed decision block 516 determines that a user has provided input indicating an intent to invite others to access the object, then add invitees block 518 directs a user through a set of options. For example, the contributor may be presented with a snippet of code (not shown) that the user can easily copy/paste it into their own website/blog/profile page on server 106 for instance.

Second timeout decision block 520 determines whether a second prescribed time period has elapsed since the user responded to one or more of decision blocks 506, 509, 512 and 516. If the second time period has not elapsed, then the flow of the process returns to decision block 506. If the second time period has elapsed, then the process 500 ends.

Thus, a requesting user of the first device 102 may assemble a contribution selection object 400D, for example, that is customized not only through selection of a group of items, but also through prioritization and comments. Object assembly information identifying the selected items, their prioritization and the comments is transmitted from the first device 102 to the first server 104 in the course of the first session SA. An assembled object is shared with potential contributors' devices as described below. The user might provide introductory comments to relate a personalized story as to why he or she is asking for the items, for example. The user can add comments associated with individual items to further explain the reason for asking for those particular items. The prioritization provides an organizational framework by which the requesting user and actual or prospective contributors can track contribution amounts.

Moreover, the requesting user can limit distribution of the object to select persons. For example, the requestor might include a link to the object on a ‘private’ social networking site.

In some embodiments, a contribution solicitation object cannot be further modified by a requesting user once it has been distributed or made available to potential contributors. One reason for this no modification rule is to ensure that potential contributors can feel confident that the nature and scope of the solicitation will not change after they have committed to make a contribution. A part of the appeal of the contribution solicitation object is believed to be that potential contributors can perceive not only exactly what the requesting user seeks, but also what impact their contribution will have upon the requestor's achieving his or her goals. Preventing changes to the object once it has been distributed or made available, ensures that potential contributors can feel confident in their assessments of the impact of their contributions, which may serve as encouragement for them to contribute.

### Contributing Based Upon a Contribution Solicitation Object

Once a contribution solicitation object has been assembled and made available to one or more potential contributors who are users of one or more second devices 103. Those users can establishes sessions SB1 and/or SB2 over the network 108 to the first server 104 with the first server 104 to request a web page containing the object and contributor GUI controls. Alternatively, a potential contributor may cause his or her device 103 to establish a session with the second server 106, which for example, may be a social networking site or a personal blog that provides access to the sought after web page. For example, the site or blog typically will contain a simplified view of the solicitation object which can be interacted with or simply can act as a link into a site portraying the object.

FIG. 6 is an illustrative screen display 600 including the contribution solicitation object 400D and contributor GUI controls 402 produced on a display screen 113 of a second device 103 operated by a potential contributor. In some embodiments, the contribution solicitation request object 400D displayed using contributor device 103 has an appearance that is substantially the same as it had when displayed for the requesting user of the first device 102. However, identical appearance of the object to the requestor and to the contributor or even to different contributors is not essential. What is more important is that the requestor's requested items, their priority, requestor's comments and item prices be made available to potential contributors through a display of the object 400D. Requestor GUI controls 601, such as “share” and GUI “invite” controls are displayed with the object 400D. In addition, requestor GUI controls point-and-click commands used to enter comments or monetary amounts. Moreover, in some embodiments, requestor GUI controls also include slider controls.

As shown in FIGS. 4A-4C and FIG. 6, each screen display assembly also includes GUI monitoring elements. The monitoring elements include a contribution meter 410 implementing a thermometer-like progress marker, an arrow progress marker 412 and purchase status fields 414. Each of these monitoring elements provides an indication of monetary amounts committed or paid toward acquisition of items shown on the object display. It will be appreciated that these GUI monitoring elements are most useful for monitoring contributions after the object has been assembled and distributed. Therefore, they may readily be omitted form screen displays of objects that have not yet been distributed.

More particularly, for example, the contribution meter 410 shown in FIG. 6 comprises an elongated horizontal bar image that includes locations labeled, from left to right, “1”, “2”, “3” and “4” to correspond to the prioritization order of like-prioritized items shown on the display. The contribution meter 410 is used to indicates a cumulative amount contributed toward the purchase of the group of items. The labeling correlates the cumulative amount with items that can be purchased using that cumulative amount. The contribution meter 410 is used to show an allocation of the cumulative amount toward the purchase of items in priority order beginning with the highest priority item and ending with the lowest priority item.

Still referring to FIG. 6, further assume for the purposes of this example, that the price associated with the first priority item 406 is $10; that the price associated with the second priority item 408 is $12; that a price associated with the third priority item 202 is $6; and that the price associated with the fourth priority item 404 is $18. In that case, a location labeled “1” on the contribution meter 410 corresponds to a total contribution of $10. A location labeled “2” on the contribution meter 410 corresponds to a total cumulative contribution of $22. A location labeled “3” on the contribution meter 410 corresponds to a total cumulative contribution of $28. A location labeled “4” on the contribution meter 410 corresponds to a total cumulative contribution of $46. In some embodiments, differences in spacing between markings on the contribution meter that correspond to the listed items are in proportion to the dollar differences in price between the items. Thus, for example, spacing between markings indicating items “2” and “3” is one-half of the spacing between markings indicating items “3” and “4”.

Still referring to FIG. 6, a progress marker graphically indicates the amount contributed so far toward the purchase of the group of items shown in the object display 400D. Three types of progress markers are displayed with the object 400D. A first type of progress marker includes an arrow marker labeled 412 that points to a location on the contribution meter 410 indicative of the total amount contributed so far. In this example, the arrow 412 points to a location between the location on the contribution meter 410 labeled “2” that corresponds to the second priority item 408 and the location labeled “3” that corresponds to third priority item 202. The arrow progress marker 412 in the illustrative example, therefore, indicates that contributions received or promised so far are sufficient to purchase the two highest priority items indicated by the object display 400D items 406 and 408. The arrow progress marker 412 also indicates that the next contributions will goes toward purchase of the third priority item 202, and that some money already has been promised or received toward the purchase of the third priority item 202.

In some embodiments, the arrow progress marker 412 indicates the relative amount of money promised toward the purchase of the next item in priority. Continuing with the above example, if $26 has been pledged or received so far, then the first $22 would be allocated toward the purchase of the top two priority items 406 and 408, and the remaining $4 would be allocated toward the purchase of the third priority item 202. Since $4 is two-thirds of the amount required to purchase the third priority item 202, the arrow progress marker 412 points at a location on the contribution meter 410 that is two-thirds of the distance from contribution meter locations “2” and “3” going from left to right.

A second type of progress marker includes a thermometer-like marker embedded in the contribution meter 410. The amount or volume of shading or coloring of the contribution meter 410 indicates the cumulative contribution amount so far. In the illustrated example, the amount of shading is proportionate to the amount of money received or committed so far. The second type progress marker indicates the same location as the arrow progress marker 412. In particular, shading or color of the contribution meter 410 to the left of the location indicated by the arrow progress marker 412 is different from color or shading to the right of that location.

A third type of progress marker includes purchase status fields 414 adjacent the items shown on the contribution selection object display 400D. The fields provide indications of which items can be purchased with the cumulative amounts promised or received so far. In this example, the purchase status fields adjacent to images of the top two priority items 406 and 408 have check marks indicating that those two items can be purchased with amounts promised so far.

Now, continuing to refer to FIG. 6, and continuing with the contributions example described above with reference to FIG. 4B, assuming that $26 already had been pledged previously, then a ‘thermometer reading’ on the contribution meter 410 and an arrow progress marker 412 both indicating $26. Moreover, the purchase status fields 414 adjacent items 406 and 408 of object 600 would indicate that sufficient monetary contribution had been committed to acquire those two items. Following this example, if a contributor were to contribute an additional $4 then the ‘thermometer’ reading on the contribution meter 410 and the (arrow) position marker 412 would move to the location labeled “3”. In addition, such entry of $4 would result in indications of sufficient contributions to purchase in the progress fields 414 adjacent items 406, 408 and 202.

In some embodiments, the position marker 412 comprises a GUI ‘slider’. Movement of the slider 412 by a potential contributor causes a corresponding monetary amount to appear in the “enter amount” field that represents the additional contribution required to match the new position of the progress marker 412. For example, continuing with the above example in which $26 had been contributed previously (e.g., by others), and assuming that the “amount” field initially contains a zero ($0.00) amount, further assume that a potential contributor slides the position marker 412 to the “3” location on the contribution meter 412. In that case, the amount $4 would appear in the “amount” field. Thus, the potential contributor would know that an additional $4 contribution was required to acquire item “3”. In some embodiments, such slider position marker 412 cannot be moved to a contribution meter location corresponding to an amount below the cumulative amounts already contributed. For instance, assuming that $26 was previously committed, the slider 412 could not be moved to location “1”, which corresponds to a cumulative $10 contribution.

Conversely, in some embodiments, movement of the position marker 412 results in corresponding changes in the ‘thermometer’ marker and in corresponding changes in the progress fields 414. Continuing with the above example, moving the position marker 412 to the “3” location would result in the ‘thermometer’ reading moving to the location labeled “3” on the contribution meter 410, for example. In addition, such movement of the position marker 412 would result in indications in the progress fields 414 adjacent items 406, 408 and 202 of sufficient contributions to acquire those items.

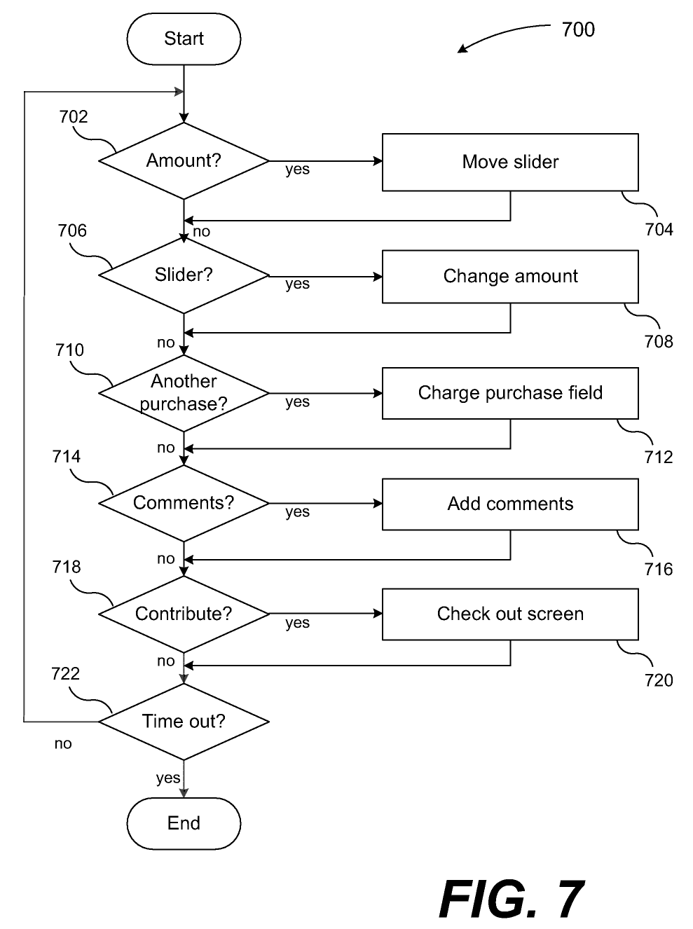

FIG. 7 is an illustrative flow diagram of a computer program controlled process 700 by which a ‘contributor’ user device 103 may use contributor user controls to make a contribution in response to the requests articulated by a contribution solicitation object such as object 400D, for example. Computer readable media is encoded with program code to implement the process 500. In some embodiments, the first server 104 cooperates with the second device 103 during implementation of the process 700. In particular, the first server 104 delivers information in the form of web pages such as the web page shown in FIG. 7 through which the user of the second device can make a contribution.

In amount decision block 702 a determination is made as to whether a user of device 103 has entered an amount into the “amount field”. If so, then in block 704, the arrow/slider 412 and thermometer readings are moved along the contribution meter 410 to a location corresponding to new cumulative amount achieved with the addition of that newly entered amount.

In slider decision block 706, a determination is made as to whether a user of device 103 has moved the arrow/slider 412 to a new location along the contribution meter 410. If so, then in block 708, an amount required to reach an cumulative amount corresponding to that new location is entered in the “amount field” that corresponds to the position of the arrow/slider 412.

In purchase decision block, a determination is made as to whether an amount indicated by the “amount field” and a cumulative amount indicated by the arrow/slider 412 is sufficient to purchase another item in the prioritized set of items. If so, then in change purchase field block 712 an indication is added to show that the amount is sufficient to purchase such item.

In comments decision block 714, a determination is made as to whether the contributor has entered comments in the “add comments” field. If so, then comments block 716 inputs the comments, which can be emailed.

In contribute decision block 718, a determination is made as to whether the potential contributor has indicated a desire to make the contribution showing in the “amount” field. If so, then in checkout block 720, a check out screen is displayed on the user device 103 whereby the user can make payments.

In timeout decision block 722, a determination is made as to whether a prescribed amount of time has elapsed since the potential contributor user began the session with the first server 104. If the prescribed amount of time has not elapsed, then the flow of process 700 returns to decision block 702. If the prescribed time has elapsed, then the process 700 ends.

Thus, each of multiple contributing users can make changes to a contribution selection object, such as object 400D. Moreover, through the progress markers 410, 412 and 414, potential contributors can keep track of overall contribution status. In addition, interactive GUI controls allow a potential contributor to explore the impact of different contribution amounts upon the requestor's goals before actually deciding upon a contribution amount.

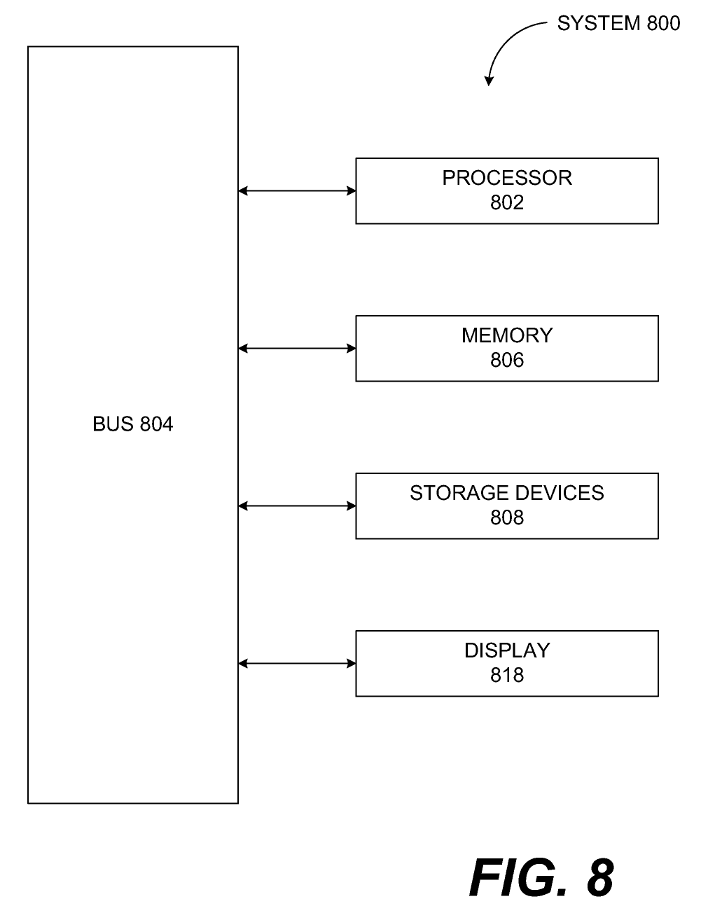

FIG. 8 is an illustrative block level diagram of a processing system 800 that can be programmed to implement processes involved with assembling a contribution solicitation object and with sending first controls over a network to a requestor's device and with sending second controls with the object over a network to a potential contributor's device. Processing system 800 may be embodied in any number of different devices such as one or more computer systems. Processing system 800 can include one or more processors, such as a processor 802. Processor 800 can be implemented using a general or special purpose processing engine such as, for example, a microprocessor, controller or other control logic. In the example illustrated in FIG. 8, processor 802 is connected to a communication channel, i.e., bus 804 or other communication medium.

Processing system 800 also can include a main memory 806, preferably random access memory (RAM) or other dynamic memory, for storing information and instructions to be executed by processor 802. Main memory 806 also may be used for storing temporary variables or other intermediate information during execution of instructions to be executed by processor 802. Processing system 800 can likewise include a additional storage devices such as read only memory (“ROM”), a hard disk, a floppy disk, magnetic tape, optical disk, a CD or DVD, Flash storage or other fixed or removable medium to store static information and instructions for processor 802. The main memory 806 and the storage devices 808 may store data such as program code instructions to cause a requestor's device to produce first controls for use to assemble a contribution solicitation objects and such as program code instructions to cause a contributor's device to produce second instructions for use to contribute to a request expressed through the object. The main memory 806 and the storage devices 808 may store instructions such as instructions to cause the devices to display the controls and to cause the devices to display an assembled object.

The processing system 800 also includes a display unit 818 that can be used to produce a display in which to display the object and the controls.

In this specification, the terms “computer program medium” and “computer useable medium” are used to generally refer to media such as, for example, memory 806, storage device 808, a hard disk installed in hard disk drive 810. These and other various forms of computer useable media may be involved in carrying one or more sequences of one or more instructions to processor 802 for execution. Such instructions, generally referred to as “computer program code” (which may be grouped in the form of computer programs or other groupings), when executed, enable the processing system 800 to perform features or functions of the present invention as discussed herein.

The foregoing description and drawings of preferred embodiments in accordance with the present invention are merely illustrative of the principles of the invention. Various modifications can be made to the embodiments by those skilled in the art without departing from the spirit and scope of the invention, which is defined in the appended claims.

What is claimed is:

1. A method to promote the acquisition of a set of items comprising:
sending first GUI controls over a network to a first device;
receiving from the first device over the network, assembly information for a contribution solicitation object; and
sending the object and second GUI controls over the network to a second device.

2. The method of claim 1 further including:
receiving an indication of a contribution from the second device over the network.

3. The method of claim 1 further including:
sending to the second device an indication of contributions committed by other contributors in response to the object.

4. The method of claim 1,
wherein the first GUI controls comprise controls to assemble of the object using the first device.

5. The method of claim 1,
wherein the assembly instructions include an identification of requested items.

6. The method of claim 1,
wherein the assembly instructions include an identification of requested items and prioritization of the requested items.

7. The method of claim 1,
wherein the assembly instructions include an identification of requested items and requester comments associated with the requested items.

8. The method of claim 1,
wherein the second GUI controls comprise controls to evaluate different contributions using the second device.

9. The method of claim 1,
wherein the second GUI controls comprise controls to make a contribution using the second device.

10. The method of claim 1,
wherein sending first GUI controls over a network to a first device includes sending a web page that includes the first GUI controls.

11. The method of claim 1,
wherein sending the object and second GUI controls over the network to a second device includes sending a first web page that includes the object and second GUI controls.

12. The method of claim 1,
wherein sending the object and second GUI controls over the network to a second device includes sending a second web page that includes the object and second GUI controls; and further including:
sending in the second web page an indication of contributions committed by other contributors in response to the object.

13. The method of claim 1,
wherein the assembly instructions include an identification of requested items and prioritization of the requested items; and
wherein the object includes instructions for the display by the second device of images indicative of requested items and prioritization of such requested items according to the assembly instructions.

14. The method of claim 1,
wherein the assembly instructions include an identification of requested items and requestor comments associated with the requested items; and
wherein the object includes instructions for the display by the second device of images indicative of requested items and comments associated with the requested items according to the assembly instructions.

15. The method of claim 1,
wherein the assembly instructions include an identification of requested items and prioritization of the requested items and requestor comments associated with the requested items; and
wherein the object includes instructions for the display by the second device of images indicative of requested items and prioritization of such requested items and comments associated with the requested items according to the assembly instructions.

16. An article of manufacture including a computer readable medium encoded with computer instructions to perform a process comprising:
sending first GUI controls over a network to a first device;
receiving from the first device over the network, assembly information for a contribution solicitation object; and
sending the object and second GUI controls over the network to a second device.

17. The article of claim 16, the process further including:
receiving an indication of a contribution from the second device over the network.

18. The article of claim 16, the process further including:
sending to the second device an indication of contributions committed by other contributors in response to the object.

19. The article of claim 16,
wherein the assembly instructions include an identification of requested items and prioritization of the requested items.

20. The article of claim 16,
wherein the assembly instructions include an identification of requested items and requestor comments associated with the requested items.

21. The article of claim 16,
wherein the second GUI controls comprise controls to evaluate different contributions using the second device.

22. The article of claim 16,
wherein the second GUI controls comprise controls to make a contribution using the second device.

23. The article of claim 16,
wherein sending first GUI controls over a network to a first device includes sending a web page that includes the first GUI controls.

24. The article of claim 16,
wherein sending the object and second GUI controls over the network to a second device includes sending a web page that includes the object and second GUI controls.

25. The article of claim 16,
wherein the assembly instructions include an identification of requested items and prioritization of the requested items and requestor comments associated with the requested items; and
wherein the object includes instructions for the display by the second device of images indicative of requested items and prioritization of such requested items and comments associated with the requested items according to the assembly instructions.

26. An apparatus to promote the acquisition of a set of items comprising:
a processor system;
memory storage; and
a bus to communicate information between the processor and memory storage;
wherein the memory is encoded with computer readable information to cause the processor system to perform a process including:
sending first GUI controls over a network to a first device;
receiving from the first device over the network, assembly instructions for a contribution solicitation object; and
sending the object and second GUI controls over the network to a second device.

27. The method of claim 26, the process further including:
receiving an indication of a contribution from the second device over the network.

28. The article of claim 26, the process further including:
sending to the second device an indication of contributions committed by other contributors in response to the object.

29. The method of claim 26,
wherein the assembly instructions include an identification of requested items and prioritization of the requested items.

30. The method of claim 26,
wherein the assembly instructions include an identification of requested items and requestor comments associated with the requested items.

31. The method of claim 26,
wherein the second GUI controls comprise controls to evaluate different contributions using the second device.

32. The method of claim 26,
wherein the second GUI controls comprise controls to make a contribution using the second device.

33. The method of claim 26,
wherein sending first GUI controls over a network to a first device includes sending a web page that includes the first GUI controls.

34. The method of claim 26,
wherein sending the object and second GUI controls over the network to a second device includes sending a web page that includes the object and second GUI controls.

35. The method of claim 26,
wherein the assembly instructions include an identification of requested items and prioritization of the requested items and requestor comments associated with the requested items; and
wherein the object includes instructions for the display by the second device of images indicative of requested items and prioritization of such requested items and comments associated with the requested items according to the assembly instructions.
